(19) United States
(12) Patent Application Publication
(10) Pub. No.: US 2010/0240455 A1
(43) Pub. Date: Sep. 23, 2010

(54) PRESENTING SECONDARY CONTENT FOR A WAGERING GAME

(75) Inventors: Mark B. Gagner, West Chicago, IL (US); Jacek A. Grabiec, Chicago, IL (US); Michael J. Irby, II, Chicago, IL (US); Scott H. Schulhof, Chicago, IL (US); Tracey L. Wright, West Chicago, IL (US)

Correspondence Address: WMS GAMING (DELIZIO GILLIAM);C/O DELIZIO GILLIAM, PLLC, 15201 MASON ROAD, SUITE 1000-312, CYPRESS, TX, 77433, US

(73) Assignee: WMS Gaming, Inc., Waukegan, IL (US)

(21) Appl. No.: 12/741,643

(22) PCT Filed: Oct. 29, 2008
(86) PCT No.: PCT/US08/81643

§ 371 Date: May 6, 2010

Related U.S. Application Data
(60) Provisional application No. 60/986,729, filed on Nov. 9, 2007.

(51) Int. Cl. A63F 13/00; A63F 9/24

(52) U.S. Cl. 463/30; 463/42

(57) ABSTRACT

Described herein are processes and devices that cause secondary content to be presented during wagering games. One of the devices described is a secondary content server. The secondary content server can obtain user related information, like user preferences, about a player of a wagering game and use the user related information to determine or generate secondary content. The secondary content server can cause the secondary content to be presented on a wagering game device or terminal. The secondary content server can determine if more than one device can present the secondary content. In some embodiments, the secondary content server presents the secondary content on a wagering game device. However, if other devices are connected to the wagering game device, the secondary content server may instead cause the secondary content to be presented on one of the other devices.

### RELATED APPLICATIONS

This application claims the priority benefit of U.S. Provisional Application Ser. No. 60/986,729 filed Nov. 9, 2007.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2008, WMS Gaming, Inc.

### BACKGROUND

1. Technical Field

Embodiments of the inventive subject matter relate generally to wagering game systems, and more particularly to devices and processes that cause secondary content to be presented during wagering games of wagering game systems and networks.

2. Background Information

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

### SUMMARY

In some embodiments, a method comprises determining a player identifier associated with a wagering game player; using the player identifier to access a user account comprising one or more user preferences; comparing the one or more user preferences to secondary content, wherein said comparing comprises analyzing the secondary content to find a correlation with the one or more user preferences, resulting in correlated secondary content; generating control information that references the correlated secondary content; and causing a device to process the control information to present the correlated secondary content during the wagering game.

In some embodiments, the secondary content comprises wagering game content that is ancillary to the wagering game but that can affect the wagering game.

In some embodiments, the secondary content comprises an advertisement.

In some embodiments, the secondary content comprises any one or more of audio information, interactive objects, text messages, schedule information, secondary game information, side bets, and user generated content.

In some embodiments, the secondary content comprises an object that alters characteristics based on game related information.

In some embodiments, the collection of secondary content comprises wagering game related information and a plurality of secondary content objects, and wherein said comparing comprises analyzing the wagering game related information to find a correlation with the one or more user preferences resulting in correlated wagering game related information, and analyzing the wagering game related information to find a correlation with one or more of the plurality of secondary content objects, resulting in one or more correlated secondary content objects.

In some embodiments, causing a device to process the control information comprises: causing the device to process the control information to associate the correlated wagering game related information with the correlated secondary content object to generate a secondary content notification, and causing the device to process the control information to present the secondary content notification in close proximity to wagering game content

In some embodiments, causing the device to process the control information comprises causing the device to present the secondary content as close as possible to the wagering game content without interfering with the presentation of game play elements that affect or display an outcome of the wagering game.

In some embodiments, a network, comprises a wagering game server comprises a primary content unit configured to control wagering game content to be presented during a wagering game, a secondary content unit configured to determine secondary content to be presented contemporaneously with the wagering game content during the wagering game, a user account manager configured to access a user accounts that contain user related information, and a presentation coordinator configured to utilize the user related information to determine the secondary content; and a wagering game client to present the wagering game content and the secondary content.

In some embodiments, the presentation coordinator is further configured to compare the user related information to the secondary content, comprising analyzing the secondary content to find a correlation with the user related information, resulting in correlated secondary content; and generate control information that references the correlated secondary content.

In some embodiments, the network further comprises a community server configured to store the user account.

In some embodiments, the network further comprises an ad server configured to store the secondary content as one or more advertisements.

In some embodiments, the secondary content comprises content that can affect the wagering game.

In some embodiments, the wagering game device comprises a primary display section configured to present any one or more of the wagering game and the secondary content, and a secondary display section configured to display the secondary content, wherein the secondary display section is configured to be movable in relation to the primary display section.

In some embodiments, a method comprises determining one of a plurality of a remote wagering game terminals on which wagering games are being presented; determining secondary content to present during the wagering games; determining a second device connected to the wagering game terminal, said second device being capable of presenting the secondary content; determining that the second device is available to present the secondary content; and causing the second device to present the secondary content during the wagering game.

In some embodiments, the one of the plurality of remote wagering game terminals is connected to a docking station and the second device is a display device that is connected to or part of the docking station.

In some embodiments, determining secondary content to present during the wagering games comprises determining one or more user accounts associated with a player of the wagering game; determining a preference setting for secondary content from the one or more user accounts; and using the preference setting to determine the secondary content.

In some embodiments, determining that the second device is available comprises determining that the second device has available resources to present the secondary content.

In some embodiments, the secondary content comprises an advertisement.

In some embodiments, the secondary content comprises any one or more of audio information, interactive objects, text messages, schedule information, secondary game information, side bets, and user generated content.

### BRIEF DESCRIPTION OF THE DRAWING(S)

Embodiments of the invention are illustrated in the Figures of the accompanying drawings in which:

FIG. 1 is an illustration of a wagering game system 101 within an operating environment 100, according to some embodiments of the invention;

FIG. 2 is an illustration of a wagering game system architecture 200, according to some embodiments of the invention;

FIG. 3 is an illustration of a wagering game network 300, according to some embodiments of the invention;

FIG. 4 is an illustration of determining secondary content based on user account information and preferences, according to some embodiments of the invention;

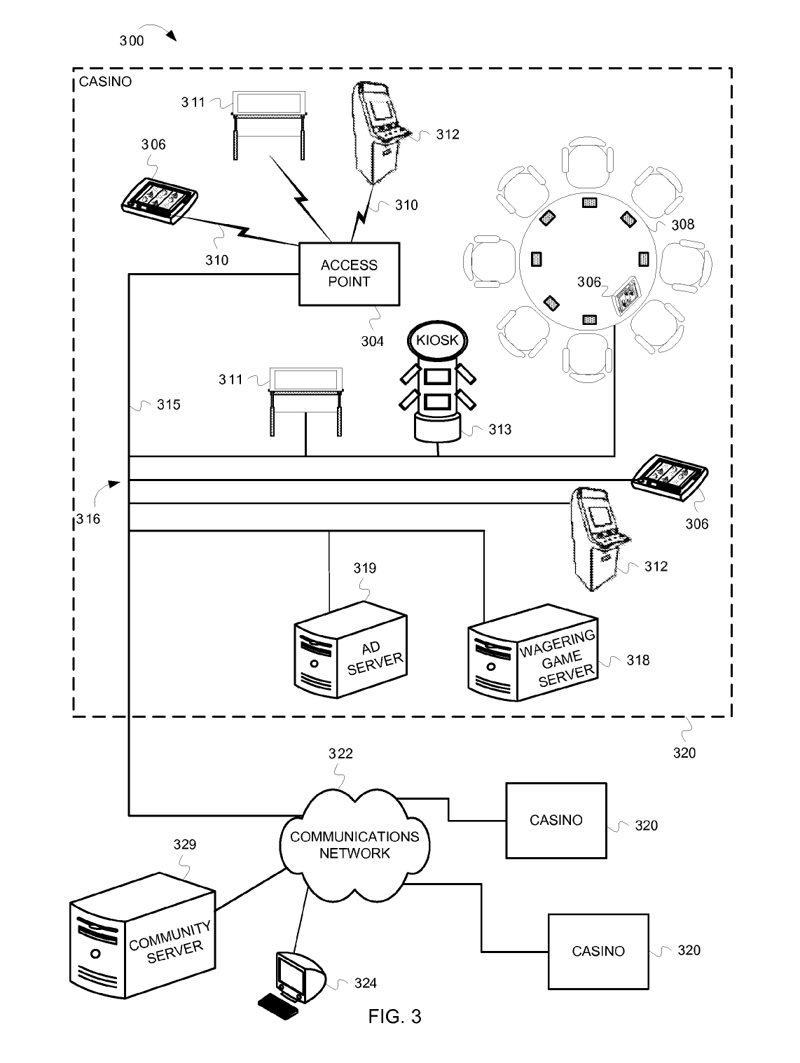

FIG. 3 is an illustration of determining other devices associated with a wagering game device to display secondary content, according to some embodiments of the invention;

FIG. 6 is a flow diagram 600 illustrating determining secondary content based on user account information and preferences, according to some embodiments of the invention;

FIG. 7 is a flow diagram 700 illustrating determining other devices associated with a wagering game device to display secondary content, according to some embodiments of the invention; and

FIG. 8 is an illustration of a wagering game device architecture 800, according to some embodiments of the invention.

### DESCRIPTION OF ILLUSTRATIVE EMBODIMENTS

This description of the embodiments is divided into five sections. The first section provides an introduction to embodiments of the invention, while the second section describes example operating environments. The third section describes example operations performed by some embodiments, while the fourth section describes some additional embodiments of operating environments. The fifth section presents some general comments.

### Introduction

This section provides an introduction to some embodiments of the invention.

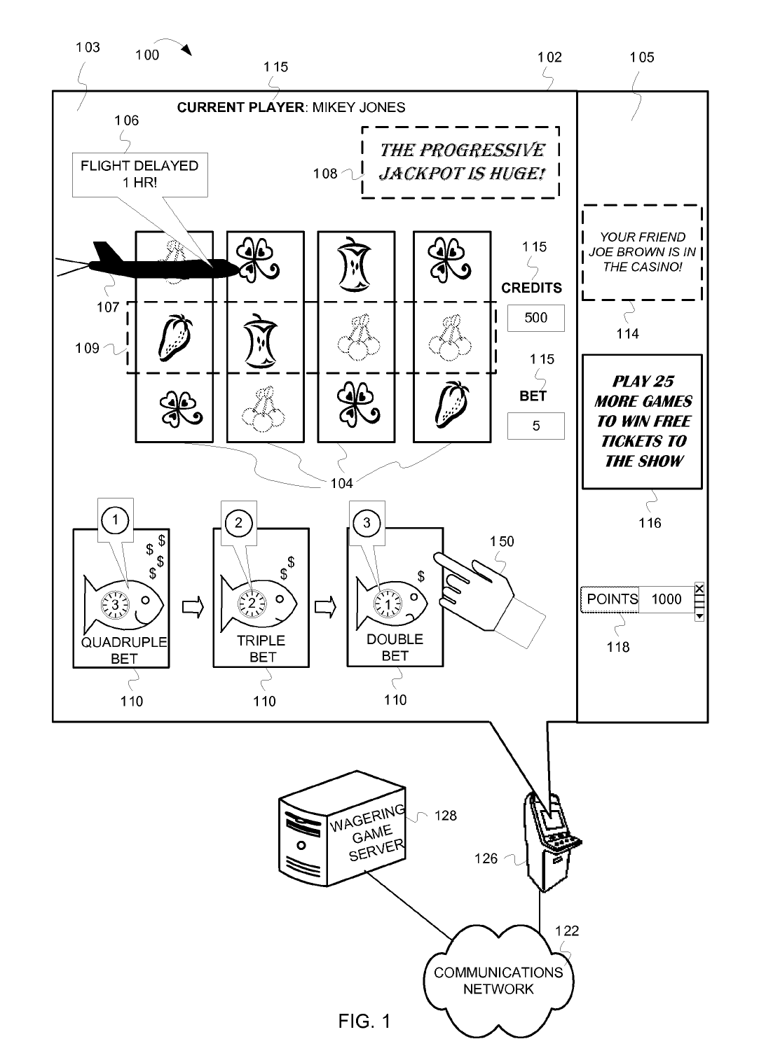

Wagering games are designed to be exciting and enjoyable. Many times wagering game players become so involved in excitement of wagering games that they do not participate in other casino activities. To encourage players to participate in other casino games and activities, casinos can use advertisements and other notifications to notify players of interesting activities, games, and events. Unfortunately, when playing their favorite wagering games, players can tune out sights and sounds outside of those wagering games. FIG. 1 shows how a wagering game device can notify players by presenting “secondary content” during wagering games.

FIG. 1 is an illustration of a wagering game system 101 that presents wagering games and secondary content, according to some embodiments of the invention. The wagering game system 101 is depicted as including a wagering game device 126 and a wagering game server 128. This depiction illustrates that elements of the wagering game system 101 can reside in both the wagering game device 126 and the wagering game server 128. In other embodiments, however, the wagering game system 101 may be entirely contained within the wagering game device 126. The wagering game system 101 is connected to a communications network 122. The wagering game device 126 presents wagering game content and secondary content on a wagering game display (“display”) 102. In FIG. 1, the wagering game is depicted by one or more slot reels 104, although the wagering game could be a wagering game other than a slots game. The slot reels 104 represent “primary” content, or content that is intended for the player's primary focus. The wagering game device 126 presents the primary content in a primary content section 103 of the display 102. The primary content section 103 also presents other information 115, such as a player's name or account information, like game credits or bank account balances. The primary content and other information can be provided by a wagering game server 128 that works in conjunction with the wagering game device 126. The wagering game system 101 determines secondary content to present within the display 102 during, or in association with, wagering games. In other words, the wagering game system 101 presents secondary content along with primary content.

Secondary content can include information (e.g., pictures, graphics, sounds, etc.) that alerts or notifies players to something ancillary to the primary content. Examples of secondary content include advertisements, reminders, additional wagering game information, etc. The wagering game system 101 can present secondary content automatically, without action from players. However, players can interact with some types of secondary content after the secondary content has been presented.

The wagering game system 101 presents the secondary content based on pre-determined rules or logic. The wagering game system 101 can process the rules, or logic, to control and prioritize how primary and secondary content is presented. For example, the wagering game system 101 can generate priority information to determine the timing and positioning of the primary and secondary content, such as how intrusive the secondary content appears in relation to primary content. For instance, the wagering game system 101 determines the priority of secondary content by evaluating the importance, or urgency, of the secondary content. If the secondary content is less important than the primary content, then the wagering game system 101 may superimpose the secondary content over primary content in a minimally intrusive manner (e.g., near the bottom of the primary content, partially transparent in relation to the primary content, etc.) Contrarily, if the secondary content is very important or urgent, then the wagering game system 101 may minimize the primary content display and expand the display size of the secondary content to become very noticeable. Furthermore, the wagering game system 101 can present secondary content according to specific timing. For instance, the wagering game system 101 can wait until opportune times to present secondary content, such as in-between game play (e.g., during or between reel spins, immediately after reel spins, etc.) In some embodiments, the wagering game system 101 can present secondary content, or cause secondary content to be presented, according to criteria such as a player's location, game profitability, game popularity, game sponsor, player status, user preferences, etc.

FIG. 1 illustrates how the wagering game system 101 presents the secondary content in the form of secondary content notifications 106, 107, 108, 110, 114, 116, 118. The secondary content notifications 106, 107, 108, 110, 114, 116, 118 are related to a secondary game, an event, a message, etc. The wagering game system 101 presents some notifications (e.g., 106, 107, 108, 110) directly within the primary content section 103 depending on the importance of the notification, or how closely related it is to the primary content. However, the wagering game system 101 presents other notifications, (e.g., 114, 116, 118) in a secondary content section 105. The secondary content section 105 can be a part of the display 102, but is separated from the primary content section 103. Secondary content notifications 106, 107, 108, 110, 114, 116, 118 can be presented in different ways. For example, the secondary content notification 106 is a message regarding the player's schedule, such as travel plans, flight schedules, dinner appointments, events that the player registered for, etc. The secondary content notification 106 can be in visual or audio format. The secondary content notification 107 accompanies the secondary content notification 106 and consists of a graphic that conveys meaning regarding the secondary content. For example, the secondary content notification 107 is shaped like an airplane to visually clue the player to the meaning of the secondary content. The wagering game system 101 determines that the secondary content notifications 106 and 107 include content that is urgent for the player to known, and thus controls and prioritizes the secondary content notifications 106 and 107 for maximum notoriety, but minimal impact on the wagering game. For instance, the wagering game system 101 determines that for maximum notoriety, the secondary content notifications 106 and 107 should move across the primary content display section 103, for example, superimposed over a portion of the reels 104. However, for minimum impact on the wagering game, the secondary content notifications 106 and 107 avoid appearing over the central row 109 of slot reel symbols.

The wagering game system 101 presents the secondary content notification 108 to inform the player of a secondary game, such as a progressive wagering game. The secondary content notification 108 may flash in and out of the primary content section 103, but not be superimposed over the slot reels 104. In other words, according to priority information, the secondary content notification 108 is important or interesting enough to be presented within the primary content section 103, but not important or interesting enough to be superimposed over the slot reels 104.

The wagering game system 101 presents the secondary content notification 110 on the primary content section 103 as an indicator of a potential wager multiplier. The secondary content notification 110 gradually changes characteristics in relation to a game related condition or factor, such as time, spin outcomes, bonuses, etc. For example, in stage “1”, the secondary content notification 110 begins as a healthy looking fish offering the player with an opportunity to quadruple their next bet. As time progresses, however, the fish changes in appearance. In stage “2”, the fish is less healthy, and offers only a triple bet. Finally, in stage “3”, as time progresses the fish changes further in appearance (e.g., becomes thinner, becomes more transparent, etc.) and offers only a double bet. The secondary content notification 110 is sensitive to touch or external input, such as by pressing a finger 150 or by using another item (e.g., stylus, wand, laser, keypad, etc.), to select the secondary content notification 110. The player can interact with the secondary content notification 110 at any stage, or leave it alone until it disappears from the display 102.

The wagering game system 101 can also present secondary content notifications 114, 116, 118, in the secondary content section 105. The secondary content section 105 can be adjacent to the primary content section 103 as shown in FIG. 1, such as in a pane, frame, or other such compartment. The secondary content section 105, however, can also be separated from the primary content section 103, such as in nearby devices or screens. In some embodiments, the designated secondary content display section 105 can be a toolbar, sidebar, floating layer, or other such similar object that can be dragged around and placed in certain parts of the display 102. In one embodiment, within the secondary content section 105, the wagering game system 101 presents the secondary content notification 114, which notifies the player that a friend has entered the casino and/or logged in to the casino network. In another embodiment, wagering game system 101 presents the secondary content notification 116, which indicates a potential prize for playing a specific number of games, or presents an advertisement for a casino event. In some embodiments, the wagering game system 101 presents the secondary content notification 118, which indicates that points are awarded or used in relation to the primary content or the secondary content. For example, the points could relate to a social network account. The points could be used to affect both primary and secondary content, such as to play the wagering game, to purchase tickets to events displayed by secondary content notifications, to cause secondary content notifications to remain on a screen longer, etc. In some embodiments, the secondary content notifications (e.g., 106, 107, 108, 110, 114, 116) are transient, existing for a pre-determined period of time instead of remaining within the display 102. However, in other embodiments, the notifications can appear in an area continuously, such as secondary content notification 118, which remains in the secondary content section 105 until closed or minimized by the player.

Although FIG. 1 describes some embodiments, the following sections describe many other features and embodiments.

### Example Operating Environments

This section describes example operating environments and networks and presents structural aspects of some embodiments. More specifically, this section includes discussion about wagering game system architectures, systems and networks.

### Example Wagering Game System Architecture

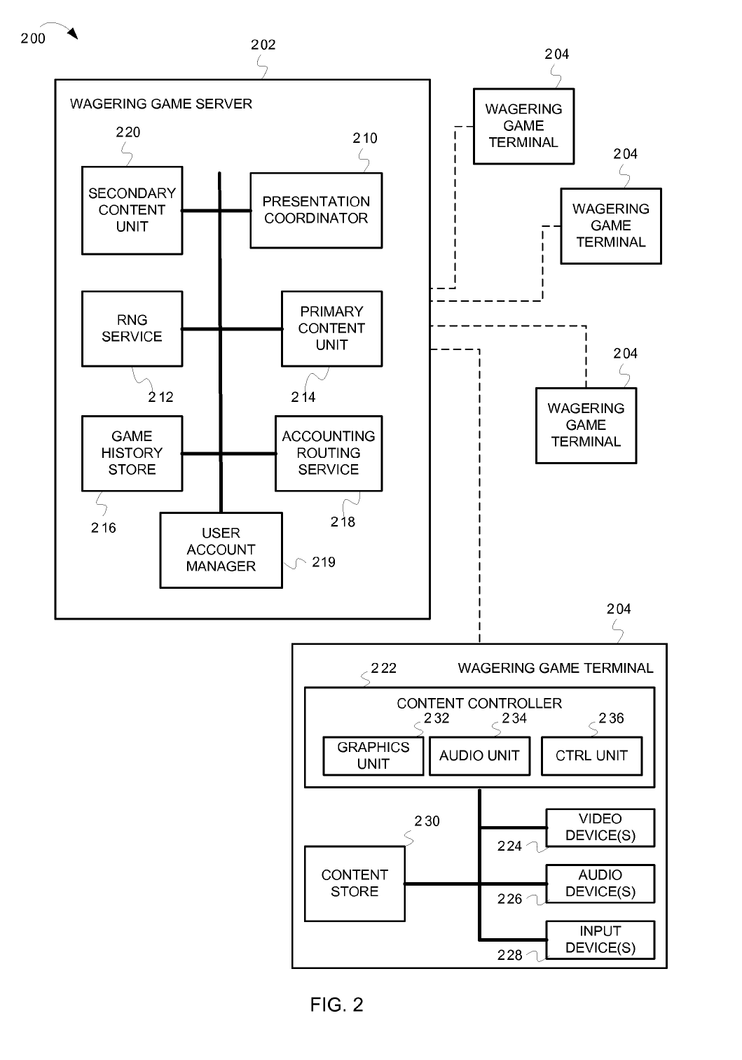

FIG. 2 is an illustration of a wagering game system architecture 200, according to some embodiments of the invention. In FIG. 2, the architecture 200 includes a wagering game server (“server”) 202 and wagering game terminal (“terminal”) 204. In some embodiments, the server 202 controls wagering games, while the terminal 204 presents game results and other content. Although FIG. 2 shows only four terminals 204, the server 202 can interact with any number of terminals (e.g., banks of stationary wagering game terminals and numerous mobile terminals in one or more casinos). In some embodiments, some components contained within the server 202 may be contained within the terminal 204, enabling the terminals 204 to present secondary content without interacting with the server 202.

The server 202 includes a presentation coordinator 210, random number generator service 212, game history store 216, and accounting routing service 218. The presentation coordinator 210 can configure, launch, and terminate primary content units and secondary content units. The presentation coordinator 210 can also maintain a list of all terminals with which it interacts.

The primary content unit 214 can offer a plurality of primary wagering game types (e.g., slots, poker, roulette, etc.) and themes (e.g., a movie theme, cartoon theme, etc.). The secondary content unit 220 can offer a plurality of secondary wagering games (a.k.a. bonus games), advertisements, alerts, messages, and other secondary content notifications. In some embodiments, secondary content is triggered by events in primary games. Alternatively, secondary content may be triggered by events independent of any primary content. For example, casino events, changes in travel plans, availability of show tickets, etc. can trigger presentation of secondary content. Additionally, players can buy into a secondary game in which one randomly selected player wins a progressive jackpot irrespective of any primary game.

The presentation coordinator 210 can maintain a list of all active terminals. The primary and secondary content units 214 & 220 can host wagering games and receive player input from the terminal 204. When hosting wagering games, the primary and secondary content units 214 & 220 can use the random number generator service 212 to determine wagering game results. The primary and secondary content units 214 & 220 can send control information to the terminal 204, where the control information indicates results for the wagering games and control and/or priority information for secondary content presentation. For example, the control information can instruct the terminal 204 to present a specific outcome for a wagering game (e.g., a certain reel combination for a slots game). In turn, the terminal 204 can present content indicting the results. In some embodiments, control information can instruct the terminal 204 to present other secondary content, such as advertising, attract modes, player messages, travel plans, user account points, etc. The control information can utilize the priority information to determine how the secondary content will be presented on the terminal 204. The control information can be in any format understood by the terminal 204.

In some embodiments, the presentation coordinator 210 utilizes user account information and preferences to determine secondary content to display. Consequently, the wagering game system architecture 200 can include a user account manager 219, to access user account information for an active player. The presentation coordinator 210 can then parse information and preferences from the user account, and utilize the information and preferences to determine secondary content from the secondary content unit 220.

The server 202 also includes an accounting routing service 218, which can distribute wagering game information (e.g., wager amounts, winning awards, etc.) between primary and secondary content units 214 & 220, an account server (not shown), and other components of the wagering game architecture 200.

The terminal 204 can act as a smart client device capable of transmitting player input to the server 202, processing control information, and rendering primary and secondary content. The terminal 204 includes a content store 230 and a presentation controller 222. The presentation controller 222 includes a control unit 236, graphics unit 232, and audio unit 234. The control unit 236 can process control information and request operations from the other components. In response to the control information, the graphics and audio units 232 & 234 can present content from the content store 230. For example, if the control information instructs the terminal 204 to present a specific game result or advertisement, the graphics and audio units 232 & 234 present the game result or advertisement using audio and graphic content in the content store 230. The control information can instruct the presentation controller 222 to present any type of information, such as game results, player messages, attract modes, advertising, hotel information, etc.

The presentation controller's graphics and audio units 232 & 234 can include audio codecs, video codecs, graphics processing engines, physics engines, and any other devices suitable for presenting audio and video content. The content store 230 can include animation data, game art (e.g., JPEG files, PCX files, etc.), audio content (e.g., MP3 files, WAV files, etc.), prerecorded video (e.g., MPEG files, AVI files, etc.), text, metadata (e.g., audio & video configuration data), etc.

The content store's content can be updated anytime. As a result, the architecture 200 can change a game's look and feel without changing the underlying game logic. For example, the terminal 204 can download new graphics that represent playing cards in a video poker game. The video poker game will look different because the playing card graphics are different. However, the new graphics will not affect how the game is played. Updating content in the content store 230 can also change the look and feel of advertising, player messages, etc.

The terminal 204 also includes video device(s) 224, audio device(s) 226, and input device(s) 228. The video device(s) 224 can include LCD devices, plasma display devices, and other suitable display devices. The audio device(s) 226 can include audio hardware (e.g., a sound card), audio speakers, and other audio presentation devices.

When the terminal 204 initializes, it can register with the server's presentation coordinator 210 to determine what types of primary and secondary wagering games it will offer.

Although not shown in FIG. 2, the terminal 204 can receive control information from other components, such as advertising servers, messaging servers, hotel information servers, etc. As a result, the terminal 204 can present content in response to control information from various sources. In some embodiments, the terminal 204 can be included in wagering game machines or other devices, such as cell phones, notebook computers, etc.

### Control Information

The control information can include initial game states, intermediate game results, final game results, and more. For example, control information can include any of the following:
Initial Game States—Control information can indicate how a wagering game initially appears to a player. The initial game state can include an initial arrangement of game elements for card games, picking games, etc.
Intermediate Game Results—Control information can indicate what game elements should be shown as games progress, but before they are final. Intermediate results can indicate values for game elements, such as cards, slots reels, game tokens, etc.
Final Game Results—Control information can indicate how game elements should be arranged in games' final states, whereby the game elements indicate whether players won or lost wagers.
Content Parameters—Control information can identify other content for presentation on the terminal 204. For example, the control information can specify content from the content store 230, such as animations, live video feeds, recorded video, graphics, etc. The control information can also specify locations in the player interface, timing, volume, and other parameters.
Other Information—The control information can include instructions to initiate new games, which may cause terminals scale content and perform other operations (see discussion of FIG. 2). The control information can also include information for configuring terminal components.
Secondary Content Information—The control information can include instructions to present specific secondary content, such as advertisements, notifications, messages, etc.

### Priority Information

Because terminals can present a plurality of primary and secondary content (e.g. see FIG. 1), some embodiments assign a priority to content presentation requests. Terminals can use priority to resolve conflicts when they receive multiple content presentation requests from multiple system components (e.g., primary game units, secondary game units, advertising servers, etc.). Criteria for determining priority can include:
Source Identifier—Priority can be based on the source of control information that includes a request to present content (e.g., a particular wagering game server or a particular primary content unit).
Presentation Request Type—Control information can request content presentations for primary content and secondary content. The different request types can have different priorities.
Timing—Priority can be based on the time at which content presentation requests are sent, received, or otherwise processed.
Component State—Priority can be based on states associated with components that request content presentation. In some embodiments, primary and secondary content units can be in states such as: initiation state (i.e., about to begin play or presentation of content), playing or presentation state, status update state (e.g., changing status of a credit meter), idle, etc. The following is an example of states and priority. The primary content unit 214 and the secondary content unit 220 can each conduct and provide content for a specific terminal. When both the primary and secondary units are in an idle state, the secondary content may have higher priority. Higher priority can cause the secondary content to appear in a larger display area, to be superimposed over other content, etc. If secondary content, like a secondary wagering game, moves to an active state, like a playing state, its priority may be heighted above the primary content in an idle state. If both are active, playing, etc., the primary content may have higher priority. Similarly non-gaming request sources (e.g., an advertising server) can also have different states.

Terminals can use priority to determine: display areas for selected content, overlay ordering for different content occupying the same space, size, etc. Furthermore, the terminal (or other components) can store tables and other data for determining priority.

### Example Wagering Game Network

FIG. 3 is an illustration of a wagering game network 300, according to some embodiments of the invention. In FIG. 3, the wagering game network 300 includes a plurality of casinos 320 connected to a communications network 322. Each casino 320 includes a local area network 316, which includes an access point 304, one or more servers (e.g., wagering game server 318 and ad server 319), and wagering game machines 306, 311, 312. In one embodiment, the local area network 316 may also include other types of servers, such as a promotions server, a player information server, a management server, progressive servers, player tracking servers, file servers, web servers, application servers, database servers, and casino and player account servers. There are many other devices, in other embodiments, that are not shown but that may exist in a wagering game network (e.g., routers, switches, monitoring equipment, etc.). The access point 304 provides wireless communication links 310 with wagering game machines 306, 311, 312. The local area network 316 may also include wired communication links 315 to connect to servers 318, 319, wireless access point 304, wagering game machines 306, 311, 312, one or more docking stations 308 and one or more kiosks 313 for storing mobile machines. The wired and wireless communication links can employ any suitable connection technology, such as Bluetooth, 801.11, Ethernet, public switched telephone networks, SONET, etc. In some embodiments, the servers 318, 319 can serve wagering games and distribute content to devices located in other casinos 320 or at other locations on the communications network 322.

The wagering game machines 306, 311, 312 described herein can take any suitable form, such as floor standing models (e.g., 312), handheld mobile units (e.g., 306), bar-top models, workstation-type console models, surface computing machines (e.g., 311), etc. Further, the wagering game machines 306, 312 can be primarily dedicated for use in conducting wagering games, or can include non-dedicated devices, such as mobile phones, personal digital assistants, personal computers, etc.

In some embodiments, wagering game machines 306, 311, 312 and the wagering game server 318 work together such that the wagering game machines 306, 311, 312 can be operated as a thin, thick, or intermediate client. That is, the wagering game machines 306, 311, and 312 can operate as wagering game terminals (see discussion of FIG. 2). In some embodiments, one or more elements of game play may be controlled by the wagering game machines 306, 311, 312 (client) or the wagering game server 318. Game play elements can include executable game code, lookup tables, configuration files, game outcome, audio or visual representations of the game, game assets or the like. In a thin-client example, the wagering game server 318 can perform functions such as determining game outcome or managing assets, while the wagering game machines 306, 311, 312 can present a graphical representation of such outcome or asset modification to the user (e.g., player). In a thick-client example, the wagering game machines 306, 311, 312 can determine game outcomes and communicate the outcomes to the wagering game server 318 for recording or managing a player's account. Similarly, in a thick-client example, the wagering game machines 306, 311, 312 can determine and present secondary content.

In some embodiments, either the wagering game machines 306, 311, 312 (client) or the wagering game server 318 can provide functionality that is not directly related to game play. For example, account transactions and account rules may be managed centrally (e.g., by the wagering game server 318) or locally (e.g., by the wagering game machines 306, 311, 312). Other functionality not directly related to game play may include power management, presentation of advertising, software or firmware updates, system quality or security checks, etc.

The network 300 also includes a community server 329 connected to the communications network 322. The community server 329 can access, modify and store social network accounts. Other devices connected to the communications network 322, such as the computer 324, can access social network accounts, as well as the wagering game server 318, and the ad server 319, within the casino 320 via the communication network 322. In some embodiments, the computer 324 can connect to the wagering game server 318 to play wagering games. The ad server 319 and other secondary content servers (not shown) can also cause secondary content to be displayed within a web browser or other application that the computer 324 uses to play the wagering games. The secondary content can be interactive (e.g., clickable, savable, etc.) within the web browser or other application. For example, the computer's web browser could present a secondary content notification that advertises a discount to attend an event that occurs in the casino 320, such as a show. The secondary content notification can include a link to the casino's box office website to purchase tickets for the show. The ad server 319 could store session metadata regarding the discount, which a point of sale system could use when the player purchases tickets.

Any of the wagering game network components (e.g., the wagering game machines, servers, etc.) can include hardware and machine-readable media including instructions for performing the operations described herein. Machine-readable media includes any mechanism that provides (i.e., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

### Determining Secondary Content Based on User Account Information and Preferences

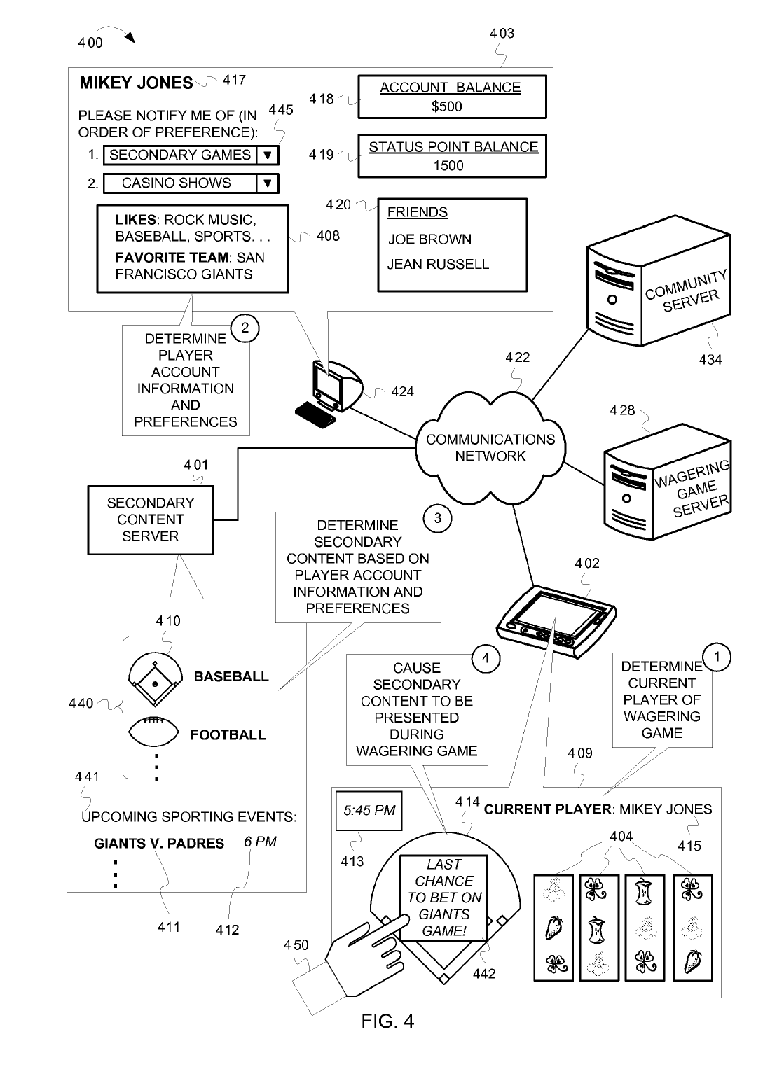

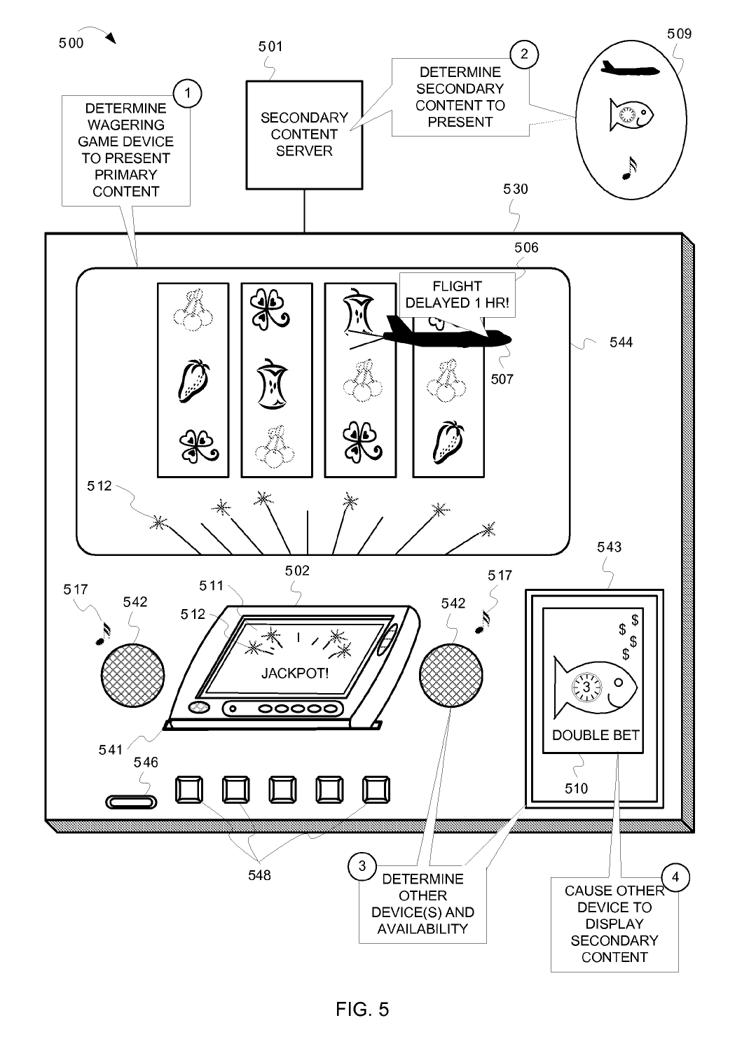

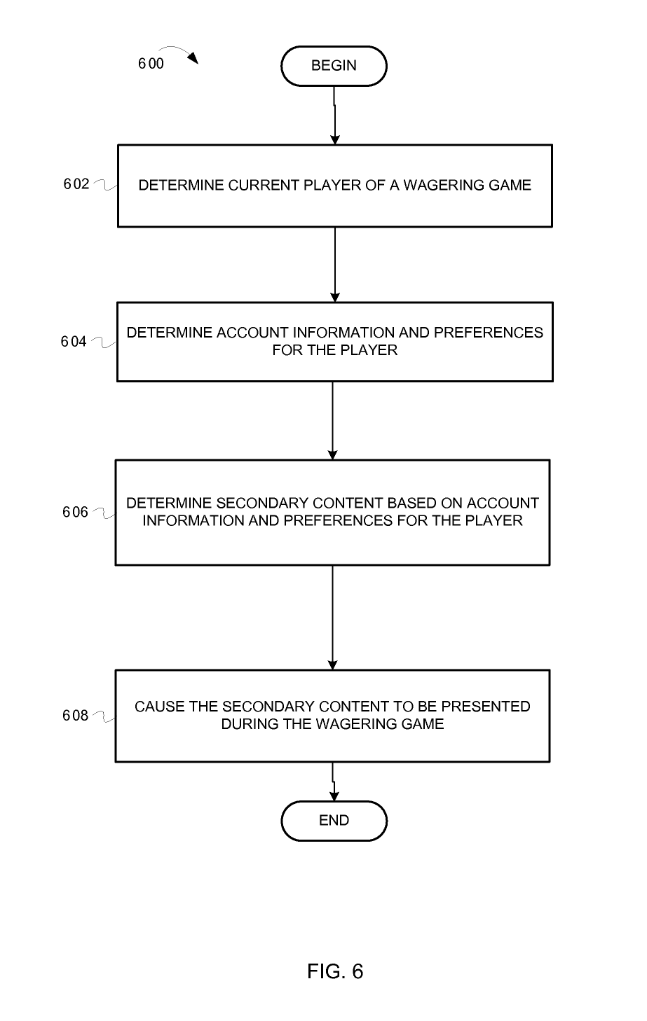

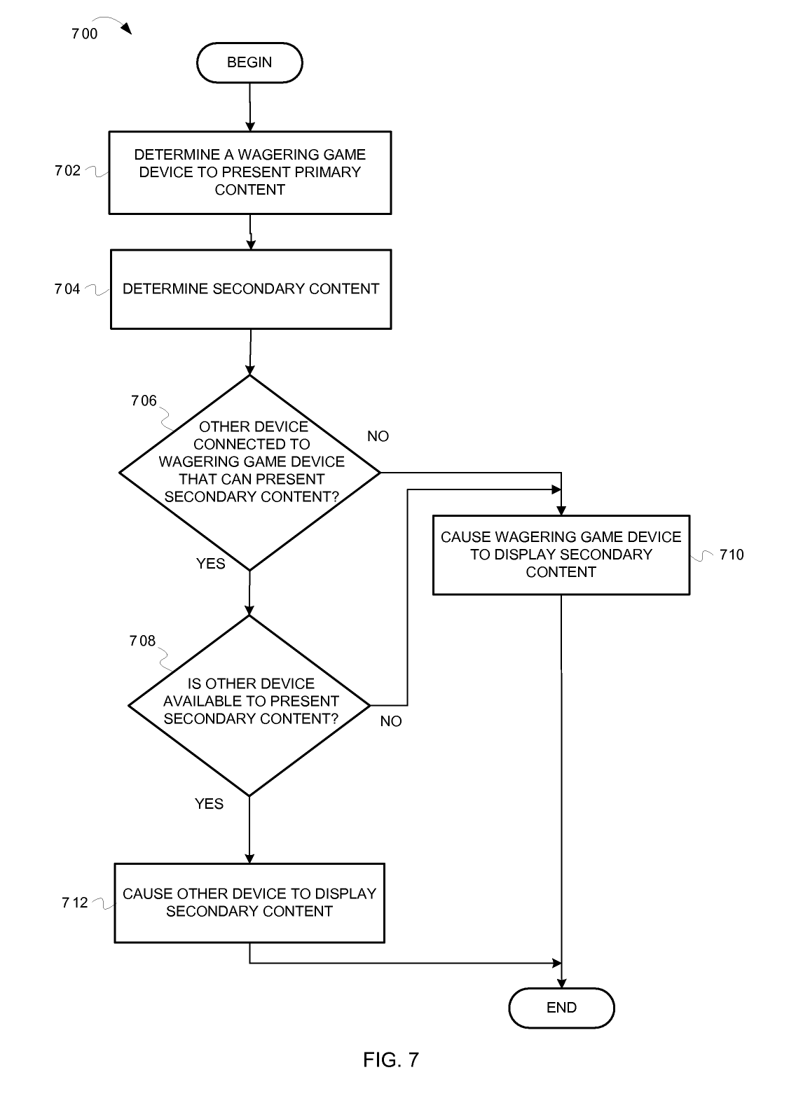

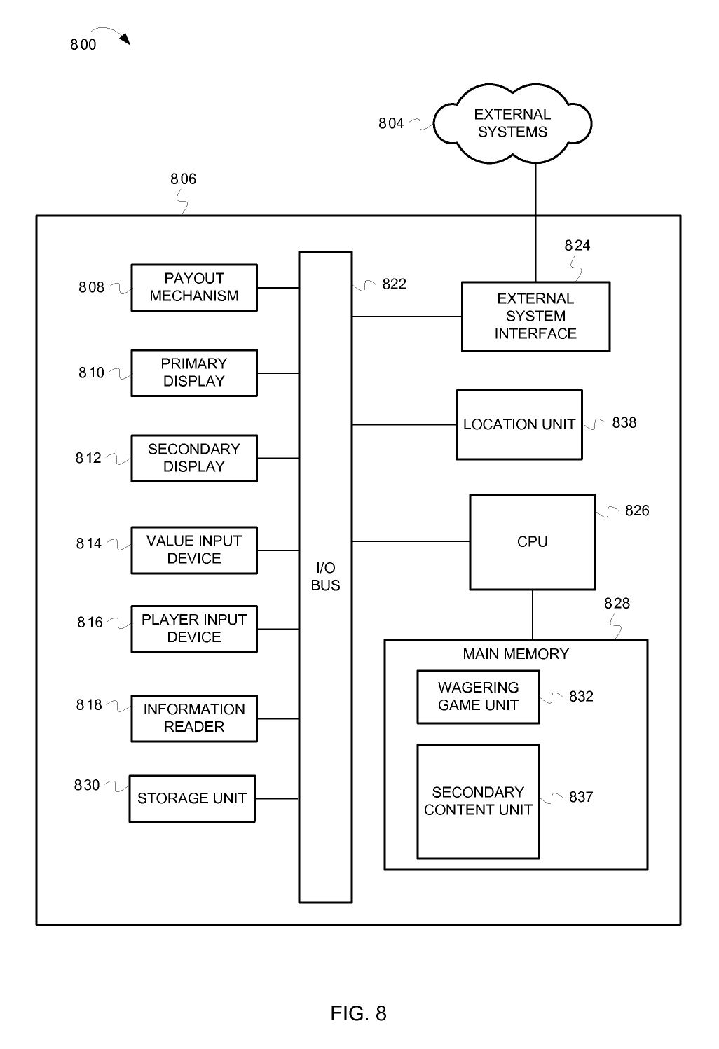

FIG. 4 is an illustration of determining secondary content based on user account information and preferences, according to some embodiments of the invention. In FIG. 4, a wagering game server 428, a secondary content server 401, a wagering game device 402, a community server 434 and a computer 424 are all connected to a communications network 422. The computer 424 can connect to the community server 434 to access and control a user account 403. The wagering game device 402 can also connect to the community server 434 to access player profiles, user accounts, etc. The wagering game server 428 and wagering game device 402 may be contained within a casino (not shown).

The wagering game device 402 can connect to the wagering game server 428 to receive control and/or priority information for presenting primary and secondary content on the wagering game device 402. For example, the wagering game device 402 includes a player interface or display (“display”) 409 to present primary content, such as a wagering game. The wagering game is represented by slot reels 404. The secondary content server 401 can cause secondary content 414 to be presented on the wagering game device 402 via the display 409. In stage “1”, to determine the secondary content 414, the secondary content server 401 first determines the current player of the wagering game. The secondary content server 401 determines the current player by reading session data for the user (e.g., player) of the wagering game device 402 or by reading data from a user account. For example, a player logs in to the wagering game device 402 using user account credentials authenticated by the wagering game server 428. The user account credentials store the player's identity 415 within session metadata, which the secondary content server 401 reads. Alternatively, the secondary content server 401 accesses the user account to ascertain information about the player's identity.

In stage “2”, the secondary content server 401 determines the player's account information and preferences. The account information and user preferences are stored in the user account 403. Account information can include account owner personal information 417, an account balance 418, a point status 419, or a list of friends 420. User preferences 408 can include a preferred interests or hobbies, preferred settings for the account, methods of preferred contact, etc. Account information and user preferences may be referred to collectively as user related information. The secondary content server 401 can access the user related information.

In stage “3”, the secondary content server 401 determines secondary content based on the user related information (e.g., player account information and preferences). For instance, the secondary content server 401 includes various types of secondary content objects 440 like templates, graphics, icons, etc. The secondary content objects 440 can be categorized by topic, for instance by sport type, by wagering game type, by casino event type, etc. The wagering game server 428 also contains, or can access, information 441 related to secondary wagering games, sports bets, casino events, community services, hospitality services, etc. (“wagering game related information”). The secondary content server 401 compares the user related information to the wagering game related information 441 to determine if there are any similarities or correlations. For example, the wagering game related information 441 contains information regarding upcoming sporting events. The secondary content server 401 knows that the wagering game player's account indicates that the player likes sports, particularly baseball. The secondary content server 401 looks up a schedule of baseball games and determines that the player's favorite baseball team is listed on a play schedule 411 with a scheduled play time 412. The secondary content server 401 analyzes the current situation to determine if the play schedule 411 and the scheduled play time 412 can potentially be used as a secondary wagering game notification. For instance, the secondary content server 401 checks the current time 413 and recognizes that the current time 413 is very close to the scheduled time 412 for the player's favorite team to play its next baseball game. The secondary content server 401 concludes that the player might respond to an opportunity to place a bet on the favorite team before play begins. Consequently, the secondary content server 401 selects one of the secondary content objects 440, such as a baseball diamond icon 410, and generates an interactive, secondary content notification 414 to notify the player about an opportunity to bet on the sporting event.

In stage “4”, the secondary content server 401 causes the secondary content to be presented during the wagering game. For instance, the secondary content server 401 sends the secondary content notification 414, or control information to assemble the secondary content notification 414, to the wagering game device 402. The wagering game device 402 may already contain a copy of the baseball diamond icon 410 and code that can assemble the baseball diamond icon 410 into the secondary content notification 414. The wagering game server 428 can generate control information to cause the wagering game device 402 to assemble the baseball diamond icon and the play schedule information 441 into the secondary content notification 414. For example, the secondary content server can manipulate information provided by the play schedule 411 to generate a message 442 related to the play schedule 411. The secondary content server 401 can also send priority information regarding the size, position, duration, etc. of the secondary content notification 414. The wagering game device 402, then utilizes content, control information, and priority information, to generate the secondary content notification 414 and present it in the display 409. The player can interact with the secondary content notification 414, such as by touching the secondary content notification with a hand 450, by clicking on the notification with a mouse pointer, by pressing a button attached to the wagering game device 402, etc. The player can also choose to ignore the secondary content notification 414 and continue playing the wagering game.

In some embodiments, the player may set user settings specifically related to secondary content notifications. For example, the user account 403 may include settings 445 that specifically list certain types of notifications that the user would prefer to receive. The secondary content server 401 can use the settings 445 to determine secondary content and to determine priority information for presenting the secondary content. The user account 403 could also allow the user to provide secondary content, such as entering messages or invitations to friends, listing scheduled events, entering travel information. Furthermore, the user account 403 can connect to other user accounts, software, databases, etc., that include user information or preferences. The secondary content server 401 can access the other user accounts, software, databases, etc. to access additional information about the player.

### Determining Devices on which to Display Secondary Content

FIG. 5 is an illustration of determining devices on which to display secondary content, according to some embodiments of the invention. In FIG. 5, an operating environment includes a secondary content server 501 connected to a docking station 530. The docking station 530 includes a docking port 541 for docking with a mobile wagering game device (“mobile device”) 502. As noted above, the mobile device 502 can operate as a terminal, as described vis-à-vis FIG. 2. The docking port 541 can include components for providing power and communications to the mobile device 502.

The docking station 530 also includes a plurality of input/output devices. In particular, the docking station 530 includes speakers 542, a primary display 544, a secondary display 543, buttons 548, and a card reader 546. While some of the input/output devices are shown as being contained within the docking station 530, they can be mounted on or about the docking station 530 at any suitable orientation.

When a mobile device 502 is docked with the docking station 530 via the docking port 541, the mobile device 502 can use any of the docking station's input/output devices. For example, the mobile device 502 can present audio on the speakers 542, and present video on the primary display 544 and secondary display 543. The mobile device 502 can also receive input through the buttons 548 and the card reader 546. However, even though the mobile device 502 is docked, in some embodiments, the mobile device 502 can still receive input through its own input/output devices.

In one embodiment, the docking station 530 includes pressure sensors and video projectors (not shown) disposed inside the docking station 530. The pressure sensors can detect when objects touch the top surface of the docking station 530, while the video projectors can project content onto the top surface of the docking station 530. In one embodiment, the docking station 530 projects content onto its top surface in response to detecting objects touching the docking station 530.

The secondary content server 501 generates or determines secondary content to be presented during a wagering game. In stage “1”, the secondary content server 501 determines a primary device, like a wagering game device (e.g., mobile device 502) that presents primary content. For example, the secondary content server 501 determines that the mobile device 502 is docked in the docking station 530. Because the wagering game device 502 is docked in the docking station 530, however, the docking station 530 presents the wagering game content, or primary content, in the primary display 544. The mobile device 502 can still communicate with a wagering game server to receive wagering game content (i.e., primary content), but the display of the content is passed on to the primary display 544. The wagering game device 502 can cause its own display 511 to power-down, or to act as a secondary content display device, like the secondary display 543.

In stage “2”, the secondary content server 501 determines secondary content 509 to display. The secondary content 509 can be one of many different types of secondary content, such as any of the secondary content notifications described in FIG. 1 above or elsewhere. In some embodiments, the secondary content server 501 evaluates criteria, circumstances, or factors, such as user related information, as described in FIG. 4, to determine or generate the secondary content 509. The secondary content server 501 can determine or generate the secondary content 509 according to a pre-determined schedule, by randomly selecting secondary content, some combination of both, or some other way.

In stage “3” the secondary content server 501 determines secondary devices, or devices other than, or in addition to, the primary device (e.g., primary display 544), on which to cause the secondary content to be presented. The secondary content server 501 analyzes the available devices to determine whether a secondary device is suited to present the secondary content 509. For example, the secondary content server 501 analyzes the priority information and may determine that the priority information indicates an urgent notification (e.g., notifications 506 and 507). The secondary content server 501, therefore, determines that even if there are other devices, like the secondary display 543, the best location for the urgent notification would be in the primary display 544. On the other hand, the secondary content server 501 may determine that the priority information indicates that the secondary content, like the secondary content notification 510, which is an interactive notification that can be touched. Consequently, the secondary content server 501 determines that the secondary display 543 is an ideal device to present the secondary content notification 510 because it is in reach of the player and has user interfacing capabilities (e.g., touch screen, mouse, touch pad, etc.). The secondary content server 501 could also determine that, if the secondary content is audio, like the audio secondary content notification 517, then the speakers 542 should present the secondary content notification 517. In some embodiments, audio based content interacts with other audio/visual elements. For example, the secondary content notification 506 could include a spoken message indicating that the flight has been delayed. Audio notifications could also be in anticipation of an upcoming notification, or a precursor notification. For instance, an audio sound could indicate that an important advertisement or secondary wagering game is about to appear in either the primary display 544 or the secondary display 543.

Once the secondary content server 501 has determined the suitability of the secondary device to present the secondary content, the secondary content server 501 determines if the secondary device is available. In other words, the secondary content server 501 determines if the secondary device has available resources to present the secondary content (e.g., available screen space, available processing power, available memory, available audio or visual capabilities, etc.). For example, the secondary content server 501 may determine secondary content that may be ideally suited to be displayed in the secondary display 543. However, other secondary content may already be displayed in the secondary display 543. The secondary content server 501, therefore, could either wait until the secondary display 543 is available, or choose the next best device to cause the secondary content to be displayed or otherwise presented. In some embodiments, the next best device could be the secondary display 511 on the mobile device 502, or the primary display 544. In some situations, the primary display 544 may be the best device to present the secondary content, but it too may be unavailable, and therefore the secondary content server 501 may wait to present the content in the primary display 544 or choose an alternative secondary device.

In stage “4”, if the secondary device is suited and available to display the secondary content, then the secondary content server 501 causes the secondary device to present the secondary content. For example, the secondary display 543 displays the secondary content notification 510 or the speakers display the secondary content notification 517. In some embodiments, the secondary content server 501 causes the secondary content to move around from secondary device to primary device or vice versa. For example, in the case of a very important, high priority notification, like the player wins a progressive jackpot on a secondary wagering game, the secondary display 511 for the docked mobile device 502 indicates a secondary content notification 512. The secondary content notification 512 begins in the secondary display 511 and spreads into the primary display 544. This is an example of high priority secondary content that can move from a secondary device to a primary device and overtake the primary content in the primary device. In other embodiments, the secondary content server 501 can move secondary content from one secondary device to another (e.g., between secondary display 543 and wagering game device display 511). The secondary content server 501 can move the secondary content between secondary devices, for example, to free up resources on a secondary device that is ideally suited to display an upcoming notification.

### Additional Embodiments of Secondary Content

FIG. 1 through FIG. 5 illustrate some embodiments to presenting secondary content in connection with a wagering game. Some other embodiments include:
A secondary content notification can be an advertisement that relates to a sponsor's account. The advertisements can be target ads that appear based on the user's preferences, user activity or history, etc.
A secondary content notification can be based on an advertising pay schedule or chart. The pay schedule or chart tracks the number of times that a secondary content notification appears during a wagering game session and bills the advertiser accordingly.
A secondary content notification can be tied to a certain manufacturer representing specific shapes or characteristics that identify the manufacturer. The secondary content notifications could also be tied to specific machines or wagering games.
A secondary content notification can be sent outside of a wagering game network, such as to a cell phone. A server can access the cell phone number by reading a user's account. The user's account could have user settings that indicate that the user would like to receive notifications on the cell phone. The secondary content notification can include an image with a message that indicates that if the user sees a similar secondary content notification the next time the user plays a wagering game at the casino, the user will receive a reward.
A secondary content notification can appear based on a player's location within a casino. If the player is close to a specific event, the secondary content notification may be tailored to advertise that specific event.
A secondary content notification can be a mass advertisement broadcast.
A secondary content notification can be a streaming broadcast, which the user can pause, stop, rewind or fast forward.
A secondary content notification can be presented as an additional element or a modified element of the wagering game, such as an additional, modified or wild character on a slot reel.
A secondary content notification can be used to invite players to events hosted by friends. The friends can be listed in the player's user account. The friends can indicate the event through their own user accounts.
A secondary content notification can utilize a player's avatar, or other identifying information, as obtained from the user's account. The avatar or identifying information can be manipulated to appear in the secondary content.
A secondary content notification can interact with other client applications such as Instant Messaging applications, telephony, casino services software, social network games, etc.
A secondary content notification can be stored or downloaded to a device, such as to a player card, an attachable hard drive, a cell phone, or other such device. The secondary content notification can then be referenced or used later. For example, the secondary content notification can be attached to an email message, saved in a user account, uploaded to a wagering game device, or printed.
A secondary content notification can pull information from a player's scheduler or organizer database. Information could include phone calls, alarms, emails, etc.

### Example Operations

This section describes operations associated with some embodiments of the invention. In the discussion below, some flow diagrams may be described with reference to the block diagrams presented above. However, in some embodiments, the operations can be performed by logic not described in the block diagrams.

In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flow diagram.

FIG. 6 is a flow diagram illustrating determining secondary content based on user account information and preferences, according to some embodiments of the invention. In FIG. 6, the flow 600 begins at processing block 602, where a secondary content server determines a current player of a wagering game. A player logs in to a wagering game device or wagering game website using credentials that can be authenticated by a wagering game server. When the user logs in to the wagering game device, or when the user logs in to the wagering game website through a browser interface, the device, or browser, captures the user's log in information. The secondary content server can utilize the log in information to access an account server where the user's account information is stored. The account information includes identification information regarding the player. The secondary content server can determine the current player by reading data stored in the user's account.

The flow 600 continues at processing block 604, where the secondary content server determines account information and preferences for the player. The account information and preferences are stored in the user account mentioned above. The user account can include data such as account balances, information regarding social network status points, a list of social contacts and friends, a list of likes or dislikes, and/or settings regarding the user's preferences. The secondary content server can read any or all of this data. The account information and user preferences can be collectively referred to as user related information.

The flow 600 continues at processing block 606, where the secondary content server determines secondary content based on account information and preferences (i.e., user related information) for the player. The server, or other device, includes various types of secondary content objects (e.g., templates, icons, graphics, sound files, etc.) that can be presented during, or in conjunction with, a wagering game. In some embodiments, the secondary content objects may be stored on the client wagering game device itself, instead of on the server, but the server has a list of the objects stored on the client. The secondary content objects can be categorized by topic, for instance by sport type, by wagering game type, by casino event type, etc. The wagering game server also contains, or can access, information of interest that can be used in secondary content notifications (e.g., ads, messages, secondary wagering games, etc.). The information of interest relates to items or events of interest, such as wagering games, sports bets, casino events, community services, hospitality services, etc. The information of interest is information related to wagering games or wagering game networks (e.g., secondary wagering games, advertisements for casino shows, casino hospitality, wagering game related social network messages, etc.). Consequently, the information of interest may be referred to as “wagering game related information”, or information that relates to wagering game related networks. The secondary content server is configured to notify the wagering game player of the wagering game related information using notifications that will be presented during the wagering game. However, the wagering game related information is copious. To better target the wagering game related information that would be of most interest to the wagering game player, the secondary content server can determine wagering game related information to present to the wagering game player based on the player's user related information. The secondary content server compares the user related information obtained from the user account to the wagering game related information to determine if there are any similarities or correlations. For example, the wagering game related information could contain information regarding upcoming sporting events. The secondary content server, for example, may have gathered data from the user's account that the wagering game player indicated an interest in sports, particularly baseball. The secondary content server analyzes the wagering game related information to determine if any of it relates to baseball. The secondary content server determines from the user related information the player's favorite baseball team. The secondary content server searches the wagering game related information for information regarding the favorite team and determines that the player's favorite baseball team is listed on a play scheduled with a time of play. The secondary content server analyzes the current situation to determine if the wagering game related information can further be manipulated into a notification. In some embodiments, the secondary content server analyzes factors related to the wagering game, the current date and time, the player's playing history, etc. For instance, the secondary content server checks the current time and recognizes that the current time is very close to the scheduled time for the player's favorite team to play its next baseball game. The secondary content server concludes that the player would likely be interested in an opportunity to place a bet on the favorite team before play begins. The secondary content server can make conclusions based on logic or rules. Consequently, the secondary content server selects one of the secondary content objects, such as a baseball diamond icon, and generates an interactive, secondary content notification to notify the player about an opportunity to bet on the sporting event. The secondary content notification, for example, would includes the baseball diamond icon along with a message stating that the player has only a little time left to bet on the baseball game.

The flow 600 continues at processing block 608, where the secondary content server causes the secondary content to be presented during the wagering game. For instance, in one embodiment, the secondary content server causes the wagering game server to send the secondary content notification to the wagering game device. In another embodiment, the secondary content server causes the wagering game server to send information to the wagering game device to assemble the secondary content notification. The wagering game device may already contain a copy of the secondary content object and code that can assemble the secondary content object into the secondary content notification. The secondary content server generates or determines control and priority information regarding the size, position, duration, etc. of the secondary content notification. The wagering game device utilizes content, control information and priority information to generate the secondary content notification and to present the secondary content notification in close proximity to the wagering game. The wagering game devices utilizes control information to present the secondary content notification as close as possible in location to wagering game content, but not interfering with the presentation of outcome significant wagering game content. In other words, the wagering game device presents the secondary content notification without interfering with the presentation of elements of the wagering game content that display the outcome of the wagering game. The wagering game device also presents the secondary content notification without interfering with the presentation of game play elements of the wagering game that require interaction by the player to determine the outcome of the wagering game. For instance, the player may have to press buttons on a screen, aim at moving targets, or interact with some game play element so that the game can progress toward an outcome. Consequently, the wagering game device uses the control information to present secondary content, but in a way that does not cover up or distract the player from the important game play elements. In some embodiments, the wagering game device partially overlaps the secondary content notification onto the primary content, such as on the borders of the primary content, but without covering up the parts of the primary content that need to be seen to continue playing a wagering game. The player can interact with the secondary content notification, such as by touching the secondary content notification with a hand finger, or other designated device. In other embodiments, the player interacts with the secondary content notification using control devices like a mouse, a joystick, a keypad, etc. In yet other embodiments, the user interacts with the secondary content notification by using a signal like a laser or an infrared beam. In some embodiments, the secondary content server can move the secondary content notification, or a pane containing the secondary content notification, and move it around a display screen, per request of a player. The secondary content server causes the secondary content notification to move, flash, fade, change characteristics, etc. After a certain period of time, the secondary content server can cause the secondary content notification to stop being presented (e.g., turns off, disappears, reduces volume, etc.).

FIG. 7 is a flow diagram illustrating determining other devices associated with a wagering game device to display secondary content, according to some embodiments of the invention. In FIG. 7, the flow 700 begins at processing block 702, where a secondary content server determines a wagering game device to present primary content. For example, the secondary content server determines that the wagering game device is connected to one or more other devices. For instance, the wagering game device may be docked in a docking station, connected to a secondary display screen, linked with a mobile wagering game device, attached to a personal digital assistant, connected to a cell phone, etc. Because the wagering game device is connected to one or more other devices, the presentation of wagering games and other primary content may occur in the wagering game device or on any of the other devices. If the other devices present primary content, the wagering game device must communicate with the other devices to share, or pass control of primary content. The secondary content server communicates with the wagering game device to determine whether the primary device or one of the other devices, presents the primary content. The secondary content server needs to know which device presents the primary content because the secondary content server causes secondary content to be presented in a way that does not interfere with important elements of the primary content. By knowing what device is presenting the primary content, the secondary content server can then determine where to position the secondary content in relation to the primary content. The secondary content server, therefore, can minimize interference with the device that presents the primary content, unless the secondary content is important or interesting enough to be presented on the same device. The device that presents the primary content will be referred to as the “primary device.”

The flow 700 continues at processing block 704, where the secondary content server determines secondary content. The secondary content can be one of many different types of secondary content, such as any of the secondary content notifications described in FIG. 1 above, or elsewhere. In some embodiments, the secondary content server evaluates criteria, circumstances, or factors, such as a player's location (e.g., in a casino, on a wide area network, on the Internet, etc.) or user related information, as described in FIG. 4, to determine or generate the secondary content. In some embodiments, the secondary content server determines or generates the secondary content according to a pre-determined schedule. In other embodiments the secondary content server can determine or generate secondary content by randomly selecting secondary content information. In yet other embodiments, the secondary content server can determine or generate secondary content by using a combination of ways described herein.

The flow 700 continues at processing block 706, where the secondary content server determines whether one or more other devices are connected to wagering game device and are suitable for presenting secondary content. In other words, the secondary content server determines secondary devices other than, or in addition to, the primary device (e.g., wagering game device) that present the primary content. The secondary content server can cause the secondary content to be presented on one or more of the secondary devices. The secondary content server analyzes the available secondary devices to determine whether the secondary devices are suited to present the secondary content. For example, the secondary content server 501 analyzes priority information and determines that the priority information indicates an urgent notification. The secondary content server, therefore, determines that even if there are secondary devices, the best location for the urgent notification would be in the primary device. On the other hand, the secondary content server may determine that the priority information indicates that the secondary content is an interactive notification that can be touched or interacted with in some way. Consequently, the secondary content server determines whether an attached secondary device has touch screen capabilities or other ways of interacting with the interactive notification. If the secondary content is audio, or has an audio component, the secondary content server could look for a secondary device that has speakers. If the secondary device is suited to present the wagering game content, then the process continues at block 708. Otherwise, the process continues at block 710, where the secondary content server causes the primary device to display the secondary content.

The flow 700 continues at processing block 708, where the secondary content server determines whether the secondary device is available to present the secondary content. Once the secondary content server has determined the suitability of the secondary device to present the secondary content, the secondary content server also determines if the secondary device is available. In other words, the secondary content server determines if the secondary device has available resources to present the secondary content (e.g., available screen space, available processing power, available memory, available audio or visual capabilities, etc.). For example, the secondary content server may determine secondary content that may be ideally suited to be displayed in a secondary device, however other secondary content may already be displayed in the secondary device at the time, or the secondary device may be off-line or low on memory. The secondary content server, therefore, could either wait until the secondary device is available, or choose the next best device to cause the secondary content to be displayed. In some situations, the next best device could be the device with the next best capabilities for presenting the secondary content. In some situations, the primary device may be the best device to present the secondary content, but it too may be unavailable, and therefore the secondary content server could then wait to present the content on the primary device or choose an alternative secondary device. In some situations, if the best suited device is not available, the secondary content server may reevaluate the secondary content and choose different secondary content. For example, if the secondary content includes audio, but a device with speakers is not available, the secondary content server may choose different secondary content without an audio component. Alternatively, the secondary content server may modify the secondary content to be presented on the available device, for example, such as removing the audio portion and modifying the notification to use text instead of audio. If the secondary device is available to present the secondary content, then the process continues at block 712. Otherwise, the process continues at block 710.

The flow 700 continues at processing block 712, where the secondary content server causes the available secondary device to present the secondary content. In some embodiments, the secondary content server causes the secondary content to move around between devices, such as from a secondary device to a primary device, or vice versa. For example, in the case of a very important, high priority notification, like the player wins a progressive jackpot on a secondary wagering game, the secondary content server begins a notification of the jackpot on a secondary device. The secondary content server causes the notification, to spread from the secondary device to the primary device. The notification could even spread to all other secondary devices that can present the secondary content.

### Additional Example Operating Environments

This section describes example operating environments, systems and networks, and presents structural aspects of some embodiments.

### Example Wagering Game Device Architecture

FIG. 8 is an illustration of a wagering game device architecture 800. In some embodiments, the wagering game device 806 can operate as a terminal, as described above. Alternatively, it can operate as a stand-alone device capable of presenting secondary content, as described above.

In FIG. 8, the wagering game device architecture 800 includes a wagering game device 806, which includes a central processing unit (CPU) 826 connected to main memory 828. The CPU 826 can include any suitable processor, such as an Intel® Pentium processor, Intel® Core 2 Duo processor, AMD Opteron™ processor, or UltraSPARC processor. The main memory 828 includes a wagering game unit 832. In one embodiment, the wagering game unit 832 can present wagering games, such as video poker, video black jack, video slots, video lottery, reel slots, etc., in whole or part.

The CPU 826 is also connected to an input/output (“I/O”) bus 822, which can include any suitable bus technologies, such as an AGTL+ frontside bus and a PCI backside bus. The I/O bus 822 is connected to a payout mechanism 808, primary display 810, secondary display 812, value input device 814, player input device 816, information reader 818, and storage unit 830. The player input device 816 can include the value input device 814 to the extent the player input device 816 is used to place wagers. The I/O bus 822 is also connected to an external system interface 824, which is connected to external systems 804 (e.g., wagering game networks). The external system interface 824 can include logic for exchanging information over wired and wireless networks (e.g., 802.11g transceiver, Bluetooth transceiver, Ethernet transceiver, etc.)

The I/O bus 822 is also connected to a location unit 838. The location unit 838 can create player information that indicates the wagering game device's location/movements in a casino. In some embodiments, the location unit 838 includes a global positioning system (GPS) receiver that can determine the wagering game device's location using GPS satellites. In other embodiments, the location unit 838 can include a radio frequency identification (RFID) tag that can determine the wagering game device's location using RFID readers positioned throughout a casino. Some embodiments can use GPS receiver and RFID tags in combination, while other embodiments can use other suitable methods for determining the wagering game device's location. Although not shown in FIG. 8, in some embodiments, the location unit 838 is not connected to the I/O bus 822.

In one embodiment, the wagering game device 806 can include additional peripheral devices and/or more than one of each component shown in FIG. 8. For example, in one embodiment, the wagering game device 806 can include multiple external system interfaces 824 and/or multiple CPUs 826. In one embodiment, any of the components can be integrated or subdivided.

In one embodiment, the wagering game device 806 includes a secondary content unit 837. The secondary content unit 837 can process communications, commands, or other information, where the processing can determine, control and/or present secondary content during a wagering game.

Furthermore, any component of the wagering game device 806 can include hardware, firmware, and/or machine-readable media including instructions for performing the operations described herein.

The described embodiments may be provided as a computer program product, or software, that may include a machine-readable medium having stored thereon instructions, which may be used to program a computer system (or other electronic device(s)) to perform a process according to embodiments of the invention(s), whether presently described or not, because every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A method comprising:
determining a player identifier associated with a wagering game player;
using the player identifier to access a user account comprising one or more user preferences;
comparing the one or more user preferences to secondary content, wherein said comparing comprises analyzing the secondary content to find a correlation with the one or more user preferences, resulting in correlated secondary content;
generating control information that references the correlated secondary content; and
causing a device to process the control information to present the correlated secondary content during the wagering game.

2. The method of claim 1, wherein the secondary content comprises wagering game content that is ancillary to the wagering game but that can affect the wagering game.

3. The method of claim 1, wherein the secondary content comprises an advertisement.

4. The method of claim 1, wherein the secondary content comprises any one or more of audio information, interactive objects, text messages, schedule information, secondary game information, side bets, and user generated content.

5. The method of claim 1, wherein the secondary content comprises an object that alters characteristics based on game related information.

6. The method of claim 1, wherein the collection of secondary content comprises wagering game related information and a plurality of secondary content objects, and wherein said comparing comprises
analyzing the wagering game related information to find a correlation with the one or more user preferences resulting in correlated wagering game related information, and
analyzing the wagering game related information to find a correlation with one or more of the plurality of secondary content objects, resulting in one or more correlated secondary content objects.

7. The method of claim 6, wherein causing a device to process the control information comprises:
causing the device to process the control information to associate the correlated wagering game related information with the correlated secondary content object to generate a secondary content notification, and
causing the device to process the control information to present the secondary content notification in close proximity to wagering game content

8. The method of claim 1, wherein causing the device to process the control information comprises causing the device to present the secondary content as close as possible to the wagering game content without interfering with the presentation of game play elements that affect or display an outcome of the wagering game.

9. A network, comprising:
a wagering game server comprising
a primary content unit configured to control wagering game content to be presented during a wagering game,
a secondary content unit configured to determine secondary content to be presented contemporaneously with the wagering game content during the wagering game,
a user account manager configured to access a user accounts that contain user related information, and
a presentation coordinator configured to utilize the user related information to determine the secondary content; and
a wagering game client to present the wagering game content and the secondary content.

10. The network of claim 9, wherein the presentation coordinator is further configured to
compare the user related information to the secondary content, comprising analyzing the secondary content to find a correlation with the user related information, resulting in correlated secondary content; and
generate control information that references the correlated secondary content.

11. The network of claim 9, further comprising:
a community server configured to store the user account.

12. The network of claim 9, further comprising:
an ad server configured to store the secondary content as one or more advertisements.

13. The network of claim 9, wherein the secondary content comprises content that can affect the wagering game.

14. The network of claim 9, wherein the wagering game device comprises
a primary display section configured to present any one or more of the wagering game and the secondary content, and
a secondary display section configured to display the secondary content, wherein the secondary display section is configured to be movable in relation to the primary display section.

15. A method comprising:
determining one of a plurality of a remote wagering game terminals on which wagering games are being presented;
determining secondary content to present during the wagering games;
determining a second device connected to the wagering game terminal, said second device being capable of presenting the secondary content;
determining that the second device is available to present the secondary content; and
causing the second device to present the secondary content during the wagering game.

16. The method of claim 15, wherein the one of the plurality of remote wagering game terminals is connected to a docking station and the second device is a display device that is connected to or part of the docking station.

17. The method of claim 15, wherein determining secondary content to present during the wagering games comprises:
determining one or more user accounts associated with a player of the wagering game;
determining a preference setting for secondary content from the one or more user accounts; and
using the preference setting to determine the secondary content.

18. The method of claim 15, wherein determining that the second device is available comprises determining that the second device has available resources to present the secondary content.

19. The method of claim 15, wherein the secondary content comprises an advertisement.

20. The method of claim 15, wherein the secondary content comprises any one or more of audio information, interactive objects, text messages, schedule information, secondary game information, side bets, and user generated content.
